(19) United States
(12) Patent Application Publication
(10) Pub. No.: US 2011/0319572 A1
(43) Pub. Date: Dec. 29, 2011

(54) POLYOLS FROM HPPO AND POLYURETHANE PRODUCTS MADE THEREFROM

(75) Inventors: Francois M. Casati, Pfaffikon (CH); Jean-Marie Sonney, Schindellegi (CH)

(73) Assignee: Dow Global Technologies LLC, Midland, MI (US)

(21) Appl. No.: 13/254,909

(22) PCT Filed: Feb. 9, 2010
(86) PCT No.: PCT/US2010/023558

§ 371 Date: Sep. 6, 2011

Related U.S. Application Data
(60) Provisional application No. 61/157,634, filed on Mar. 5, 2009.

(51) Int. Cl. C08G 18/48; C08G 65/332; C08G 18/18; C08G 65/333

(52) U.S. Cl. 525/408; 525/409

(57) ABSTRACT

Described is a polyol blend for use in the production of polyurethane products. The polyol blend may include between about 50 and about 99 percent by weight of the polyol blend of at least one HPPO polyether polyol compound having a nominal starter functionality between about 2 and about 8 and a hydroxyl number between about 20 and about 800, and between about 1 and about 50 percent by weight of the polyol blend of at least one autocatalytic polyol.

### CROSS-REFERENCE TO RELATED APPLICATIONS

This application claims benefit of U.S. Provisional Patent Application Ser. No. 61/157,634, filed Mar. 5, 2009, entitled “ POLYOLS FROM HPPO AND POLYURETHANE PRODUCTS MADE THEREFROM” which is herein incorporated by reference.

### BACKGROUND

1. Field of the Invention

Embodiments of the present invention generally relate to polyols made from HPPO (Hydrogen Peroxide based Propylene Oxide) and low VOC (Volatile Organic Compound) polyurethane products made from the polyols; more specifically, to polyurethane with low amine VOC's.

2. Description of the Related Art

Polyether polyols based on the polymerization of alkylene oxides, polyester polyols, or combinations thereof, are together with isocyanates the major components of a polyurethane system. Polyether polyols may be manufactured by polymeric reaction of an organic oxide and an initiator compound containing two or more active hydrogen atoms. The initiator compound in the presence of proper catalyst(s) initiates ring opening of the organic oxide followed by oxide addition to the initiator compound. The oxide addition is continued until the desired molecular weight is obtained. Common organic oxides used to produce polyether polyols for polyurethane foams are ethylene oxide, 1,2-propylene oxide, and butylenes oxide. During the production of these organic oxides impurities, such as volatile organic compounds (VOC), are also formed. These impurities may follow the organic oxides in the polyol production and subsequent polyurethane production. Furthermore, fugitive amine based catalyst may also be used in the polyurethane production. The impurities and amine catalysts may result in odorous polyurethane products. Therefore, there is a need for polyurethane products with reduced amine VOC emission.

### SUMMARY

The embodiments of the present invention provide polyurethane foams based on polyols made from HPPO polyether polyol and having low VOC's.

In one embodiment of the invention a polyol blend is provided. The polyol blend includes between about 50 and about 99 percent by weight of the polyol blend of at least one HPPO polyether polyol compound having a nominal starter functionality between about 2 and about 8 and a hydroxyl number between about 20 and about 800, and between about 1 and about 50 percent by weight of the polyol blend of at least one autocatalytic polyol.

In another embodiment, a polyurethane product is provided. The polyurethane product is the reaction product of at least one organic polyisocyanate; and at least one polyol blend which includes between about 50 and about 99 percent by weight of the polyol blend of at least one HPPO polyether polyol compound having a nominal starter functionality between about 2 and about 8 and a hydroxyl number between about 20 and about 800, and between about 1 and about 50 percent by weight of the polyol blend of at least one autocatalytic polyol.

In another embodiment a method for producing polyurethane product is provided. The method includes reacting at least one organic polyisocyanate with at least one polyol blend which includes between about 50 and about 99 percent by weight of the polyol blend of at least one HPPO polyether polyol compound having a nominal starter functionality between about 2 and about 8 and a hydroxyl number between about 20 and about 800, and between about 1 and about 50 percent by weight of the polyol blend of at least one autocatalytic polyol.

### DETAILED DESCRIPTION

Embodiments of the invention provide for polyurethane products which have a reduced amine VOC emission. The polyurethane products are the reaction products of at least one isocyanate and at least one polyol blend. The polyol blend may include at least one hydroperoxide based propylene oxide (HPPO) polyether polyol and at least one autocatalytic polyol and/or reactive amine catalysts. The polyol blend may also include at least one ester group containing polyol.

The at least one HPPO polyether polyol may be derived from a propylene oxide made through the epoxidation of propene with at least one hydroperoxide. The at least one HPPO polyether polyol may be derived by methods known in the art, such as described in U.S. Patent Application Publications U.S. Pat. No. 6,284,213 and 2004/0249107, and may be available from the Dow Chemical Company under the tradename VORANOL and from BASF under the tradename LUPRANOL. The HPPO polyol may be derived through a two step process. In a first step, propene is epoxidated with at least one hydroperoxide to give the hydroperoxide based propylene oxide. The hydroperoxide may in an embodiment be hydrogen peroxide. The reaction of the propene with the at least one hydroperoxide may take place in the presence of a catalyst. The catalyst may be one that comprises a porous oxidic material, e.g. a zeolite. Catalysts which comprise a titanium-, vanadium-, chromium-, niobium-, tin-, germanium- or zirconium-containing zeolite as porous oxidic materials are preferably used. In certain embodiments, the catalyst may be a zeolite that which contains no aluminum and in which titanium as Ti(IV) is present instead of some of the Si(IV) in the silicate lattice.

In a second step, the hydroperoxide based propylene oxide may be reacted with an initiator to form the HPPO polyether polyol. The initiator may have between about 2 and about 8 active hydrogen atoms. In one embodiment the initiator may have between about 2 and about 6 active hydrogen atoms. Catalysis for this polymerization reaction may be either anionic or cationic, with catalysts such as KOH, CsOH, boron trifluoride, or a double cyanide complex (DMC) catalyst such as zinc hexacyanocobaltate or quaternary phosphazenium compounds.

Examples of suitable initiator molecules are water, organic dicarboxylic acids, such as succinic acid, adipic acid, phthalic acid and terephthalic acid and polyhydric, in particular dihydric to octahydric alcohols or dialkylene glycols, for example ethanediol, 1,2- and 1,3-propanediol, diethylene glycol, dipropylene glycol, 1,4-butanediol, 1,6-hexanediol, glycerol, trimethylolpropane, pentaerythritol, sorbitol and sucrose or blends thereof. Other initiators include compounds linear and cyclic amine compounds containing eventually a tertiary amine such as ethanoldiamine, triethanoldiamine, and various isomers of toluene diamine, ethylenediamine, N-methyl-1,2-ethanediamine, N-Methyl-1,3-propanediamine, N,N-dimethyl-1,3-diaminopropane, N,N-dimethylethanolamine, 3,3′-diamino-N-methyldipropylamine, N,N-dimethyldipropylenetriamine, aminopropyl-imidazole

The hydroperoxide based propylene oxide may be combined with the initiator alone or together with at least one further alkylene oxide. In principle, all alkylene oxides which are known to a person skilled in the art may be used, in addition to the HPPO, for the preparation of a polyether alcohol. In particular, substituted or unsubstituted alkylene oxides of 2 to 24 carbon atoms, for example alkylene oxides having halogen, hydroxyl, noncyclic ether or ammonium substituents, may be used. For example, ethylene oxide, 1,2-epoxypropane, 1,2-epoxybutane, 2,3-epoxybutane, styrene oxide, vinyloxirane and any mixtures thereof with one another may be used.

If, in addition to the HPPO, at least one further alkylene oxide is used, it is possible to use a mixture of the HPPO and at least one further alkylene oxide. However, it is also possible for the HPPO at least one further alkylene oxide to be added in succession to form block polymers.

In addition to the HPPO, other processes can be used to manufacture PO such as the chlorohydrin process or the MTBE process as described in U.S. Pat. No. 5,424,458. These conventional PO's are referred to as CHPO. These older processes generate by products able to generate VOC's (Volatile Organic Compounds) in polyurethane foams as described in WO2003/020787.

The resulting HPPO polyether polyol may have a functionality of between about 2 and about 8. All individual values and subranges between about 2 and about 8. are included herein and disclosed herein; for example, the functionality can be from a lower limit of about 2, 3, 4, 5, or 6 to an upper limit of about 4, 5, 6, 7, or 8. For example, the HPPO polyether polyol may have a functionality of between about 2 and about 7; or in the alternative, the HPPO polyether polyol may have a functionality of between about 2 and about 6; or in the alternative, the HPPO polyether polyol may have a functionality of between about 2 and about 5; or in the alternative, the HPPO polyether polyol may have a functionality of between about 2 and about 4; or in the alternative, the HPPO polyether polyol may have a functionality of between about 3 and about 8; or in the alternative, the HPPO polyether polyol may have a functionality of between about 3 and about 7; or in the alternative, the HPPO polyether polyol may have a functionality of between about 3 and about 6; or in the alternative, the HPPO polyether polyol may have a functionality of between about 3 and about 5; or in the alternative, the HPPO polyether polyol may have a functionality of between about 4 and about 6.

The resulting HPPO polyether polyol may have a hydroxyl number between about 15 and about 800, preferably between about 20 and about 150 mgKOH/g. In some embodiments the HPPO polyether polyol may have a hydroxyl number between about 28 and 100 mgKOH/g.

In the production of a flexible polyurethane foam, the HPPO polyether polyol may have an average functionality ranging from 2 to 5, preferably 2 to 4, and an average hydroxyl number ranging from 20 to 100 mg KOH/g, preferably from 20 to 70 mgKOH/g. As a further refinement, the specific foam application will likewise influence the choice of base polyol. As an example, for molded foam, the hydroxyl number of the base polyol may be on the order of 20 to 60 with ethylene oxide (EO) capping, and for slabstock foams the hydroxyl number may be on the order of 25 to 75 and is either mixed feed EO/PO (propylene oxide) or is only slightly capped with EO or is 100 percent PO based. For viscoelastic foams a polyol with OH above 100 can be included in the formulation.

For elastomer applications, it may be desirable to utilize relatively high molecular weight based polyols, from about 2,000 to about 8,000, having relatively low hydroxyl numbers, for example, 20 to 50.

Typically polyols suitable for preparing rigid polyurethanes include those having an average molecular weight of about 100 to about 10,000 and preferably about 200 to about 7,000. Such polyols also advantageously have a functionality of at least about 2, preferably about 3, and up to about 8, preferably up to about 6, active hydrogen atoms per molecule. The polyols used for rigid foams generally have a hydroxyl number of about 200 to about 1,200 and more preferably from about 300 to about 800.

For the production of semi-rigid foams, it may be preferred to use a trifunctional polyol with a hydroxyl number of about 30 to about 80.

The HPPO polyether polyols may constitute between about 40 and about 99% by weight of the total polyol blend. All individual values and subranges between about 40 and about 99% by weight. are included herein and disclosed herein. For example, the amount of HPPO polyether polyol may be from a lower limit of about 40, 45, 50, 55, 60, 65, 70, 75, 80, 85, 90, or 95% by weight to an upper limit of about 60, 65, 70, 75, 80, 85, 90, 95, 97, or 99% by weight. For example, the range may between about 50 and about 97% by weight; or in the alternative, the range may between about 50 and about 95% by weight; or in the alternative, the range may between about 50 and about 90% by weight; or in the alternative, the range may between about 50 and about 80% by weight; or in the alternative, the range may between about 50 and about 70% by weight; or in the alternative, the range may between about 50 and about 65% by weight; or in the alternative, the range may between about 60 and about 99% by weight; or in the alternative, the range may between about 60 and about 95% by weight; or in the alternative, the range may between about 60 and about 90% by weight.

In addition to the HPPO polyether polyol, the polyol blend may include at least one autocatalytic polyol. The autocatalytic polyol also may be an amine initiated polyol, i.e. a polyol made from the alkoxylation of a primary or secondary amine, or, optionally from an aminoalcohol. The amine initiated polyols have inherent autocatalytic activity and can replace a portion or all of the amine catalyst generally used in the production of flexible polyurethane foams. The autocatalytic polyols may be made from an initiator containing a tertiary amine, polyols containing a tertiary amine group in the polyol chain or a polyol partially capped with a tertiary amine group. The autocatalytic polyol may be added to replace at least 20 percent by weight of conventional amine catalyst while maintaining the same reaction profile for making polyurethane foams, alternatively, the autocatalytic polyol may be added to replace at least 30 percent by weight of the amine catalyst while maintaining the same reaction profile. Such amine initiated polyols may also be added to replace at least 50 percent by weight of the amine catalyst while maintaining the same reaction profile, alternatively, the autocatalytic polyol may be added to replace at least 75, or alternatively, the autocatalytic polyol may be added to replace at least 90 percent by weight of the amine catalyst while maintaining the same reaction profile percent by weight of the amine catalyst while maintaining the same reaction profile. Alternatively, such autocatalytic polyols may be added to enhance the demold time.

In one embodiment, the autocatalytic polyol has a weight average molecular weight between about 1000 and about 12,000 and is prepared by alkoxylation of at least one initiator molecule of the formula

HₘA-(CH₂)ₙ-N(R)—(CH₂)ₚ-AHₘ (I)

wherein n and p are independently integers from 2 to 6,

A at each occurrence is independently oxygen, nitrogen, sulfur or hydrogen, with the proviso that only one of A can be hydrogen at one time,

R is a C₁ to C₃ alkyl group,

m is equal to 0 when A is hydrogen, is 1 when A is oxygen and is 2 when A is nitrogen, or

H₂N—(CH₂)_{q}-N—(R)—H (II)

where q is an integer from 2 to 12 and

R is a C₁ to C₃ alkyl group.

In various embodiments of the invention, the initiators for the production of the autocatalytic polyols include, 3,3′-diamino-N-methyldipropylamine, 2,2′-diamino-N-methyldiethylamine, 2,3-diamino-N-methyl-ethyl-propylamine N-methyl-1,2-ethanediamine and N-methyl-1,3-propanediamine.

Other initiators include linear and cyclic compounds containing an amine. Exemplary polyamine initiators include ethylene diamine, neopentyldiamine, 1,6-diaminohexane; bisaminomethyltricyclodecane; bisaminocyclohexane; diethylene triamine; bis-3-aminopropyl methylamine; triethylene tetramine various isomers of toluene diamine; diphenylmethane diamine; N-methyl-1,2-ethanediamine, N-Methyl-1,3-propanediamine, N,N-dimethyl-1,3-diaminopropane, N,N-dimethylethanolamine, 3,3′-diamino-N-methyldipropylamine, N,N-dimethyldipropylenetriamine, aminopropyl-imidazole.

Exemplary aminoalcohols include ethanolamine, diethanolamine, and triethanolamine.

The alkoxylation of the initiator molecule may be performed using the same alkylene oxides, catalysts, and methods as described in relation to the HPPO polyether polyol, including HPPO, as well as conventionally made alkylene oxides.

The autocatalytic polyol can also contain a tertiary nitrogen in the chain, by using for example an alkyl-aziridine as co-monomer with PO and EO.

Autocatalytic polyols with tertiary amine end-cappings are those which contain a tertiary amino group linked to at least one tip of a polyol chain. These tertiary amines can be N,N-dialkylamino, N-alkyl, aliphatic or cyclic, amines, polyamines.

The autocatalytic polyols may constitute between about 1 and about 50% by weight of the total polyol blend. All individual values and subranges between about 1 and about 50% by weight. are included herein and disclosed herein. For example, the amount of autocatalytic polyol may be from a lower limit of about 1, 2, 3, 4, 5, 6, 7, 8, 9, 10, 15, 20, 25, 30, 35, or 40% by weight to an upper limit of about 10, 15, 20, 25, 30, 35, 40, 45, or 50% by weight. For example, the range may between about 5 and about 50% by weight; or in the alternative, the range may between about 10 and about 50% by weight; or in the alternative, the range may between about 15 and about 50% by weight; or in the alternative, the range may between about 20 and about 50% by weight; or in the alternative, the range may between about 25 and about 50% by weight; or in the alternative, the range may between about 10 and about 45% by weight; or in the alternative, the range may between about 15 and about 45% by weight; or in the alternative, the range may between about 20 and about 45% by weight; or in the alternative, the range may between about 25 and about 45% by weight.

Isocyanate reactive amine catalysts are have a tertiary amine moiety providing the catalytic function for the isocyanate reactions with polyols, waters, crosslinkers, etc, and a reactive hydrogen, either as an alcohol or an secondary or primary amine. Examples of such isocyanate reactive amines are DAME (N,N-Dimethylethanolamine) or DMAPA (N,N-Dimethylaminopropylamine).

The polyol blend may optionally include at least one ester group polyol. The ester group polyol is a polyol which includes at least one ester group. Examples of polyols which include at least one ester group are natural oil based polyols (NOBPs). The natural oil based polyols are polyols based on or derived from renewable feedstock resources such as natural and/or genetically modified (GMO) plant vegetable seed oils and/or animal source fats. Such oils and/or fats are generally comprised of triglycerides, that is, fatty acids linked together with glycerol. Such vegetable oils may have at least about 70 percent unsaturated fatty acids in the triglyceride. The natural product may contain at least about 85 percent by weight unsaturated fatty acids. Examples of vegetable oils include those from castor, soybean, olive, peanut, rapeseed, corn, sesame, cotton, canola, safflower, linseed, palm, grapeseed, black caraway, pumpkin kernel, borage seed, wood germ, apricot kernel, pistachio, almond, macadamia nut, avocado, sea buckthorn, hemp, hazelnut, evening primrose, wild rose, thistle, walnut, sunflower, jatropha seed oils, or a combination thereof. Additionally, oils obtained from organisms such as algae may also be used. Examples of animal products include lard, beef tallow, fish oils and mixtures thereof. A combination of vegetable and animal based oils/fats may also be used.

For use in the production of polyurethane foams, the natural material may be modified to give the material isocyanate reactive groups or to increase the number of isocyanate reactive groups on the material. Preferably such reactive groups are a hydroxyl group. Several chemistries can be used to prepare the natural oil based polyols. Such modifications of a renewable resource include, for example, epoxidation, hydroxylation, ozonolysis, esterification, hydroformylation, or alkoxylation. Such modifications are commonly known in the art and are described, for example, in U.S. Pat. Nos. 4,534,907, 4,640,801, 6,107,433, 6,121,398, 6,897,283, 6,891,053, 6,962,636, 6,979,477, and PCT publication Nos. WO 2004/020497, WO 2004/096744, and WO 2004/096882.

After the production of such polyols by modification of the natural oils, the modified products may be further alkoxylated. The use of ethylene oxide (EO) or mixtures of EO with other oxides, introduce hydrophilic moieties into the polyol. In one embodiment, the modified product undergoes alkoxylation with sufficient EO to produce a natural oil based polyol with between about 10 weight % and about 60 weight % percent EO; preferably between about 20 weight % and about 40 weight % EO.

In another embodiment, the natural oil based polyols are obtained by a multi-step process wherein the animal or vegetable oils/fats is subjected to transesterification and the constituent fatty acids recovered. This step is followed by hydroformylating carbon-carbon double bonds in the constituent fatty acids to form hydroxymethyl groups, and then forming a polyester or polyether/polyester by reaction of the hydroxymethylated fatty acid with an appropriate initiator compound. Such a multi-step process is commonly known in the art, and is described, for example, in PCT publication Nos. WO 2004/096882 and 2004/096883. The multi-step process results in the production of a polyol with both hydrophobic and hydrophilic moieties, which results in enhanced miscibility with both water and conventional petroleum-based polyols.

The initiator for use in the multi-step process for the production of the natural oil based polyols may be any initiator used in the production of the polyols previously described.

The ester group polyols may constitute between about 1 and about 50% by weight of the total polyol blend. All individual values and subranges between about 1 and about 50% by weight. are included herein and disclosed herein. For example, the amount of ester group polyol may be from a lower limit of about 1, 2, 3, 4, 5, 6, 7, 8, 9, 10, 15, 20, 25, 30, 35, or 40% by weight to an upper limit of about 10, 15, 20, 25, 30, 35, 40, 45, or 50% by weight. For example, the range may between about 5 and about 50% by weight; or in the alternative, the range may between about 10 and about 50% by weight; or in the alternative, the range may between about 15 and about 50% by weight; or in the alternative, the range may between about 20 and about 50% by weight; or in the alternative, the range may between about 25 and about 50% by weight; or in the alternative, the range may between about 10 and about 45% by weight; or in the alternative, the range may between about 15 and about 45% by weight; or in the alternative, the range may between about 20 and about 45% by weight; or in the alternative, the range may between about 25 and about 45% by weight.

The weight ratio of autocatalytic polyol and ester group polyol to HPPO polyether polyol may vary depending on the amount of additional catalyst and/or crosslinker one may desire to add to the reaction mix and depending on the reaction profile required by the specific application. The weight ratio also depends on the level and type of reactive catalysts added to the formulation. The addition of at least one autocatalytic polyol to the polyurethane reaction mixture may reduce or eliminate the need to include a conventional fugitive tertiary amine catalyst or an organometallic catalyst. Generally, a reaction mixture may have a certain level (base level) of catalyst concentration which results in a base level curing time of the reaction mixture. According to embodiments of the invention, the autocatalytic polyol and reactive catalysts may be combined in the polyol blend in amounts such that the amount of reactive catalyst may be reduced by at least 10, 15, 20, 25, 30, 35, 40, 45, 50, 55, 60, 65, 70, 75, 80, 85, 90, 95, 96, 97, 98, 99, or 100 percent by weight of the base level, while, at the same time, resulting in a reaction mixture having the same base level curing time as the base level reaction mixture. In other embodiments, the level of the autocatalytic polyol and/or reactive catalysts is where the need for a conventional, fugitive tertiary amine catalysts or organometallic or crosslinker salt is eliminated.

Alternatively weight ratio of autocatalytic polyol and ester group polyol to HPPO polyether polyol may be formulated to replace at least 20, 30, 40, 50, 60, 65, 70, 75, 80, 85, 90, 95, 97, 99, or 100 percent by weight of conventional amine catalyst while maintaining the same reaction profile for making polyurethane foams.

The polyol blend may be reacted with at least one isocyanate to form a polyurethane product. The isocyanates which may be used include aliphatic, cycloaliphatic, arylaliphatic and aromatic isocyanates. Examples of suitable aromatic isocyanates include the 4,4′-, 2,4′ and 2,2′-isomers of diphenylmethane diisocyanate (MDI), blends thereof and polymeric and monomeric MDI blends toluene-2,4- and 2,6-diisocyanates (TDI), m- and p-phenylenediisocyanate, chlorophenylene-2,4-diisocyanate, diphenylene-4,4′-diisocyanate, 4,4′-diisocyanate-3,3′-dimethyldiphenyl, 3-methyldiphenyl-methane-4,4′-diisocyanate and diphenyletherdiisocyanate and 2,4,6-triisocyanatotoluene and 2,4,4′-triisocyanatodiphenylether.

Mixtures of isocyanates may be used, such as the commercially available mixtures of 2,4- and 2,6-isomers of toluene diisocyanates. A crude polyisocyanate may also be used in the practice of this invention, such as crude toluene diisocyanate obtained by the phosgenation of a mixture of toluene diamine or the crude diphenylmethane diisocyanate obtained by the phosgenation of crude methylene diphenylamine. TDI/MDI blends may also be used. MDI or TDI based prepolymers may also be used; made either with HPPO polyether polyol, autocatalytic polyol or any other polyol as described heretofore. Isocyanate-terminated prepolymers may be prepared by reacting an excess of polyisocyanate with polyols, including aminated polyols or imines/enamines thereof, or polyamines.

Examples of aliphatic polyisocyanates include ethylene diisocyanate, 1,6-hexamethylene diisocyanate, isophorone diisocyanate, cyclohexane 1,4-diisocyanate, 4,4′-dicyclohexylmethane diisocyanate, saturated analogues of the above mentioned aromatic isocyanates and mixtures thereof.

For the production of rigid or semi-rigid foams, polymethylene polyphenylene isocyanates, the 2,2′, 2,4′ and 4,4′ isomers of diphenylmethylene diisocyanate and mixtures thereof often may be used. For the production of flexible foams, the toluene-2,4- and 2,6-diisocyanates or MDI or combinations of TDI/MDI or prepolymers made therefrom often may be used. Isocyanate tipped prepolymer based on HPPO polyether polyol and/or autocatalytic polyol may also be used in the polyurethane formulation.

For rigid foam, the organic polyisocyanates and the isocyanate reactive compounds may be reacted in such amounts that the isocyanate index, defined as the number or equivalents of NCO groups divided by the total number of isocyanate reactive hydrogen atom equivalents multiplied by 100, ranges, in the case of polyurethane foams, from about 80 to less than about 500, preferably from about 90 to about 100, and from about 100 to about 300 in the case of combination polyurethane-polyisocyanurate foams. For flexible foams, this isocyanate index may be between about 50 and about 120 and preferably between about 75 and about 110. For elastomers, coating and adhesives the isocyanate index may be between about 80 and about 125, preferably between about 100 and about 110.

For producing a polyurethane-based foam, a blowing agent may be required. In the production of flexible polyurethane foams, water may be used as a blowing agent. The amount of water may be in the range of from about 0.5 to about 10 parts by weight, preferably from about 2 to about 7 parts by weight based on 100 parts by weight of the polyol. Carboxylic acids or salts may also be used as reactive blowing agents. Other blowing agents can be liquid or gaseous carbon dioxide, methylene chloride, acetone, pentane, isopentane, methylal or dimethoxymethane, dimethylcarbonate. Use of artificially reduced or increased atmospheric pressure can also be contemplated with the present invention.

For the production of rigid polyurethane foams, the blowing agent may include water, and mixtures of water with a hydrocarbon, or a fully or partially halogenated aliphatic hydrocarbon. The amount of water is may be the range of from about 2 to about 15 parts by weight, preferably from about 2 to about 10 parts by weight based on 100 parts of the polyol. The amount of hydrocarbon, the hydrochlorofluorocarbon, or the hydrofluorocarbon to be combined with the water may be selected depending on the desired density of the foam, and may be less than about 40 parts by weight, preferably, less than about 30 parts by weight based on 100 parts by weight of the polyol. When water is present as an additional blowing agent, it may be present in an amount from about 0.5 to about 10, preferably from about 0.8 to about 6 and more preferably from about 1 to about 4 and more preferably from about 1 to about 3 parts by total weight of the total polyol composition.

Hydrocarbon blowing agents are volatile C₁ to C₅ hydrocarbons. The use of hydrocarbons is known in the art as disclosed in EP 421 269 and EP 695 322. In some embodiments. the hydrocarbon blowing agents may bet butane and isomers thereof, pentane and isomers thereof (including cyclopentane), and combinations thereof.

Examples of fluorocarbons include methyl fluoride, perfluoromethane, ethyl fluoride, 1,1-difluoroethane, 1,1,1-trifluoroethane (HFC-143a), 1,1,1,2-tetrafluoroethane (HFC-134a), pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane. Partially halogenated chlorocarbons and chlorofluorocarbons for use in the embodiments of the invention include methyl chloride, methylene chloride, ethyl chloride, 1,1,1-trichloroethane, 1,1-dichloro-1-fluoroethane (FCFC-141b), 1-chloro-1,1-difluoroethane (HCFC-142b), 1,1-dichloro-2,2,2-trifluoroethane (HCHC-123) and 1-chloro-1,2,2,2-tetrafluoroethane (HCFC-124).

Fully halogenated chlorofluorocarbons include trichloromonofluoromethane (CFC-11) dichlorodifluoromethane (CFC-12), trichlorotrifluoroethane (CFC-113), 1,1,1-trifluoroethane, pentafluoroethane, dichlorotetrafluoroethane (CFC-114), chloroheptafluoropropane, and dichlorohexafluoropropane. The halocarbon blowing agents may be used in conjunction with low-boiling hydrocarbons such as butane, pentane (including the isomers thereof), hexane, or cyclohexane or with water.

In addition to the foregoing critical components, it may be desirable to employ certain other ingredients in preparing polyurethane polymers. Among these additional ingredients are surfactants, preservatives, flame retardants, colorants, antioxidants, reinforcing agents, stabilizers and fillers, including recycled polyurethane foam.

In making polyurethane foam, it may be preferred to employ an amount of a surfactant to stabilize the foaming reaction mixture until it cures. Such surfactants may comprise a liquid or solid organosilicone surfactant. Other surfactants include polyethylene glycol ethers of long-chain alcohols, tertiary amine or alkanolamine salts of long-chain alkyl acid sulfate esters, alkyl sulfonic esters and alkyl arylsulfonic acids. Such surfactants are employed in amounts sufficient to stabilize the foaming reaction mixture against collapse and the formation of large, uneven cells. Typically, about 0.2 to about 3 parts of the surfactant per 100 parts by weight total polyol may be used for this purpose.

One or more catalysts for the reaction of the polyol (and water, if present) with the polyisocyanate may be used. Any suitable urethane catalyst may be used, including tertiary amine compounds, amines with isocyanate reactive groups and organometallic compounds. Preferably the reaction is carried out in the absence of a fugitive amine or an organometallic catalyst or a reduced amount as described above. Exemplary tertiary amine compounds include triethylenediamine, N-methylmorpholine, N,N-dimethylcyclohexylamine, pentamethyldiethylenetriamine, tetramethylethylenediamine, bis (dimethylaminoethyl)ether, 1-methyl-4-dimethylaminoethyl-piperazine, 3-methoxy-N-dimethylpropylamine, N-ethylmorpholine, dimethylethanolamine, N-cocomorpholine, N,N-dimethyl-N′,N′-dimethyl isopropylpropylenediamine, N,N-diethyl-3-diethylamino-propylamine and dimethylbenzylamine. Exemplary organometallic catalysts include organomercury, organolead, organoferric and organotin catalysts. Suitable tin catalysts include stannous chloride, tin salts of carboxylic acids such as dibutyltin di-laurate, as well as other organometallic compounds such as are disclosed in U.S. Pat. No. 2,846,408. A catalyst for the trimerization of polyisocyanates, resulting in a polyisocyanurate, such as an alkali metal alkoxide may also optionally be employed herein. The amount of amine catalysts can vary from 0.02 to 5 percent in the formulation or organometallic catalysts from 0.001 to 1 percent in the formulation can be used.

A crosslinking agent or a chain extender may be added, if necessary. The crosslinking agent or the chain extender includes low-molecular polyhydric alcohols such as ethylene glycol, diethylene glycol, 1,4-butanediol, and glycerin; low-molecular amine polyol such as diethanolamine and triethanolamine; polyamines such as ethylene diamine, xlylenediamine, and methylene-bis(o-chloroaniline). The use of such crosslinking agents or chain extenders is known in the art as disclosed in U.S. Pat. Nos. 4,863,979 and 4,963,399 and EP 549,120.

When preparing rigid foams for use in construction, a flame retardant may be included as an additive. Any known liquid or solid flame retardant may be used with the polyols described herein. Generally such flame retardant agents are halogen-substituted phosphates and inorganic flame proofing agents. Common halogen-substituted phosphates are tricresyl phosphate, tris(1,3-dichloropropyl phosphate, tris(2,3-dibromopropyl) phosphate and tetrakis (2-chloroethyl)ethylene diphosphate. Inorganic flame retardants include red phosphorous, aluminum oxide hydrate, antimony trioxide, ammonium sulfate, expandable graphite, urea or melamine cyanurate or mixtures of at least two flame retardants. In general, when present, flame retardants are added at a level of from about 5 to about 50 parts by weight, preferably, from about 5 to about 25 parts by weight of the flame retardant per 100 parts per weight of the total polyol present.

The applications for foams produced by the embodiments of the present invention are those known in the industry. For example rigid foams may be used in the construction industry and for insulation for appliances and refrigerators. Flexible foams and elastomers find use in applications such as furniture, shoe soles, automobile seats, sun visors, steering wheels, armrests, door panels, noise insulation parts and dashboards.

Processing for producing polyurethane products are well known in the art. In general components of the polyurethane-forming reaction mixture may be mixed together in any convenient manner, for example by using any of the mixing equipment described in the prior art for the purpose such as described in “Polyurethane Handbook”, by G. Oertel, Hanser publisher.

The polyurethane products may be produced continuously or discontinuously, by injection, pouring, spraying, casting, calendering, etc; these are made under free rise or molded conditions, with or without release agents, in-mold coating, or any inserts or skin put in the mold. In case of flexible foams, those can be mono- or dual-hardness.

For producing rigid foams, the known one-shot prepolymer or semi-prepolymer techniques may be used together with conventional mixing methods including impingement mixing. The rigid foam may also be produced in the form of slabstock, moldings, cavity filling, sprayed foam, frothed foam or laminates with other material such as paper, metal, plastics or wood-board. Flexible foams are either free rise and molded while microcellular elastomers are usually molded.

The polyurethane products produced in accordance with the embodiments of the invention exhibit a reduced tendency to stain vinyl films or to degrade polycarbonate sheets with which they are exposed, display excellent adhesion properties (in appropriate formulations), have a reduced tendency to produce ‘blue haze’ vision which is associated with the use of certain volatile tertiary amine catalysts, and are more environmental friendly through the reduction/elimination of organometallic catalysts.

The foams produced may, according to embodiments of the invention, have a total VOC emission below 100 parts per million (ppm), as measured by the German Association of the Automotive Industry VDA 278 test method. The VDA 278 test method is a standard polyurethane foam emission testing method used in the automotive industry to evaluate emissions from polyurethane foam under realistic conditions. All individual values and subranges below 100 ppm are included herein and disclosed herein; for example, the total VOC emission may be from a lower limit of 0.1, 0.2, 0.3, 0.4, 0.5, 0.8, 0.9, 1, 1.5, 2, 2.5, 3, 4, 5, 7, 9, 10, 12.5, 15, 17.5, 20, 25, 30, 35, 40, 45, 50, 55, 60, 65, 75, 80, 85, 90, or 95 pm to an upper limit of 5, 7, 9, 10, 12.5, 15, 17.5, 20, 25, 30, 35, 40, 45, 50, 55, 60, 65, 75, 80, 85, 90, 95, 96, 97, 98, or 99, ppm.

The foams may, according to embodiments of the invention, have total VOC amine content below 10 parts per million (ppm), as measured by the VDA 278 test method. All individual values and subranges below 10 ppm are included herein and disclosed herein; for example, the VOC amine content may be from a lower limit of 0.1, 0.2, 0.3, 0.4, 0.5, 0.6, 0.7, 0.8, 0.9, 1.0 1.2, 1.3, 1.4, 1.5, 2.0, 2.5, 3.0, 3.5, 4.0, 4.5, 5.0, 6.0, or 7.0 ppm to an upper limit of 0.5, 0.6, 0.7, 0.8, 0.9, 1.0 1.2, 1.3, 1.4, 1.5, 2.0, 2.5, 3.0, 3.5, 4.0, 4.5, 5.0, 6.0, 7.0, 8.0, 9.0, or 9.5 ppm.

### EXAMPLES

The following examples are provided to illustrate the embodiments of the invention, but are not intended to limit the scope thereof. All parts and percentages are by weight unless otherwise indicated.

The following materials were used:

| | |
|---|---|
| DEOA 85% | 85% pure diethanolamine and 15% water. |
| TEGOSTAB B-8715LF | A low fogging, silicone-based surfactant available |
| | from Goldschmidt |
| DABCO 33 LV | A tertiary amine catalyst based on TEDA |
| | (Triethylenediamine) available from Air Products |
| | and Chemicals Inc. |
| NIAX A-1 | A tertiary amine catalyst available from Crompton |
| | Corporation. |
| JEFFCAT ZF-10 | A tertiary amine catalyst containing a hydroxyl |
| | group available from Huntsman |
| JEFFCAT ZR-50 | A tertiary amine catalyst containing a hydroxyl |
| | group available from Huntsman |
| VORANOL* CP-4711 | An EO capped 5,000 MW triol based on PO made |
| | with the CHPO process and available from The |
| | Dow Chemical Company |
| VORANOL* CP 1421 | is a high EO based propoxylated triol available |
| | from The Dow Chemical Company |
| Polyol A | An EO capped 5,000 MW triol based on PO made |
| | with the HPPO process. Hence this polyol is |
| | similar to Voranol CP 4711 but based on HPPO |
| | process. |
| Polyol B | is a 1,700 EW propxylated quadrol initiated with |
| | 3,3′-N-methyl-di-propylamine and containing 15% |
| | Ethyleneoxide. PO was made by the CHPO |
| | process. |
| VORANATE* T-80 | is a toluene diisocyanate (80% 2,4-toluene |
| | diisocyanate and 20% 2,6-toluene diisocyanate by |
| | weight) composition available from The Dow |
| | Chemical Company. |
| SPECFLEX* NE-134 | is a MDI prepolymer with a 29.5% NCO content |
| | and available from The Dow Chemical Company. |

*SPECFLEX, VORANOL, and VORANATE are trademarks of The Dow Chemical Company.

All foams are made by preblending polyols, surfactants, crosslinkers, catalysts and water, conditioned at 25° C. The Isocyanate is also conditioned at 25° C. and is added under stirring at 3,000 RPM for 5 seconds. After mixing, the reactants are poured into a 30 cm×30 cm×10 cm aluminum mold heated at 60° C. which is subsequently closed. The mold has been previously been sprayed with the release agent Klueber 41-2013 available from Chem-Trend. Foam curing at 5 minutes is assessed by manually demolding the part, looking for internal and external defects. If none, the part is rated as OK. Reactivity is measured from the mold exit time, i.e. the time when foaming mass begins to appear at the mold vent holes.

One hour after production, the foams are cut to eliminate skin and packaged in Aluminum foil and plastic bags to be tested for VOC emissions according to the VDA 278 test method. Other foam properties are tested according to the ASTM D-3574 test methods

### EXAMPLES 1, 2 AND COMPARATIVE EXAMPLE 3

Three molded foams are produced; foams of examples 1 and 2 (E1 and E2) are based on polyol A, while foam of comparative example CE3, not part of this invention, is based on VORANOL CP 4711.

TABLE 1

| Example | E1 | E2 | CE3 |
|---|---|---|---|
| Polyol A | 100 | 70 | |
| Polyol B | | 30 | |
| VORANOL CP 4711 | | | 100 |
| Water | 3.5 | 3.5 | 3.5 |
| DEOA | 0.50 | 0.50 | 0.50 |
| DABCO 33 LV | | | 0.40 |
| NIAX A-1 | | | 0.05 |
| JEFFCAT ZF-10 | 0.15 | 0.05 | |
| JEFFCAT ZR-50 | 0.8 | 0.5 | |
| TEGOSSTAB B8715LF | 1.0 | 1.0 | 1.0 |
| VORANOL CP 1421 | 2.0 | 2.0 | 2.0 |
| SPECFLEX NE 134 index | 90 | 90 | 90 |
| Part weight (g) | 451 | 456 | 459 |
| Skin aspect | OK | Few basal cells | OK |
| Core density (kg/m³) | 50.5 | 50.4 | 50.9 |
| 75% Compression set (%) | 7.6 | 6.7 | 4.3 |
| Triethylenediamine VOC | 0 | 0 | 141 |
| content (ppm) | | | |
| Siloxanes VOC content | 80 | 69 | 73 |
| (ppm) | | | |
| Other amine VOC content | 0 | 0 | 0 |
| (ppm) | | | |

These data show that the use of the autocatalytic polyol and/or the reactive catalyst together with HPPO based polyol allows the production of amine VOC free foams.

### EXAMPLE 4 AND COMPARATIVE EXAMPLE 5

Foam of example 4 (E4) is based on the combination of polyol A and polyol B with reactive catalysts at low levels. Foam of comparative example 5 (CE5), not part of this invention, is based on VORANOL CP 4711 and reactive catalysts. Both foams exhibit similar reactivity and good foam physical properties.

| Example | E4 | CE5 |
|---|---|---|
| Polyol A | 70 | |
| Polyol B | 30 | |
| VORANOL CP 4711 | | 100 |
| Water | 3.5 | 3.5 |
| DEOA | 0.5 | 0.5 |
| JEFFCAT ZF-10 | 0.15 | 0.1 |
| JEFFCAT ZR-50 | 0.8 | 0.5 |
| TEGOSTAB B 8715LF | 1.0 | 1.0 |
| SPECFLEX NE 134 index | 90 | 90 |
| Mold exit time (s) | 55 | 50 |
| Core density (kg/m3) | 50.1 | 50 |
| 50% CFD (KPa) | 5.5 | 5.4 |
| Airflow (cfm) | 2.0 | 2.4 |
| 75% Compression set (%) | 6.8 | 7.1 |

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

1. A polyol blend, comprising:
between about 50 and about 99 percent by weight of the polyol blend of at least one HPPO (Hydrogen Peroxide based Propylene Oxide) polyether polyol compound having a nominal starter functionality between about 2 and about 8 and a hydroxyl number between about 20 and about 800; and
between about 1 and about 50 percent by weight of the polyol blend of at least one autocatalytic polyol or an isocyanate reactive amine catalyst.

2-17. (canceled)

18. The polyol blend of claim 1, wherein the polyol blend further comprises at least one ester group polyol.

19. The polyol blend of claim 1, wherein the at least one autocatalytic polyol is made using at least one propylene oxide based on at least one hydroperoxide.

20. The polyol blend of claim 19, wherein the at least one autocatalytic polyol comprises hydroxyl end-capping groups.

21. The polyol blend of claim 1, wherein the at least one autocatalytic polyol comprises at least one of primary and secondary amine end-capping groups.

22. The polyol blend of claim 1, wherein the at least one HPPO polyether polyol is amine initiated.

23. The polyol blend of claim 1, wherein the at least one autocatalytic polyol comprises a blend of at least two polyols with tertiary amine moieties.

24. A polyurethane product comprising the reaction product of at least:
at least one organic polyisocyanate; and
at least one polyol blend comprising:
between about 50 and about 99 percent by weight of the polyol blend of at least one HPPO (Hydrogen Peroxide based Propylene Oxide) polyether polyol compound having a nominal starter functionality between about 2 and about 8 and a hydroxyl number between about 20 and about 800, and
between about 1 and about 50 percent by weight of the polyol blend of at least one autocatalytic polyol.

25. The polyurethane product of claim 24, wherein the polyol blend further comprises at least one ester group polyol.

26. The polyurethane product of claim 24, wherein the at least one autocatalytic polyol is made using at least one propylene oxide based on at least one hydroperoxide.

27. The polyurethane product of claim 26, wherein the at least one autocatalytic polyol comprises hydroxyl end-capping groups.

28. The polyurethane product of claim 24, wherein the at least one autocatalytic polyol comprises at least one of primary and secondary amine end-capping groups.

29. The polyurethane product of claim 24, wherein the at least one HPPO polyether polyol is amine initiated.

30. The polyurethane product of claim 24, wherein the at least one autocatalytic polyol comprises a blend of at least two polyols with tertiary amine moieties.

31. The polyurethane product of claim 24, wherein the polyurethane product has a total VOC emission below 85 parts per million (ppm), as measured by the VDA 278 test method.

32. The polyurethane product of claim 24, wherein the polyurethane product has a total amine VOC emission below 10 parts ppm, as measured by the VDA 278 test method.

33. A method for producing polyurethane product comprising reacting at least:
at least one organic polyisocyanate; and
at least one polyol blend comprising:
between about 50 and about 99 percent by weight of the polyol blend of at least one HPPO polyether polyol compound having a nominal starter functionality between about 2 and about 8 and a hydroxyl number between about 20 and about 800, and
between about 1 and about 50 percent by weight of the polyol blend of at least one isocyanate reactive amine catalyst.

34. The polyurethane product of claim 34, wherein the at least one autocatalytic polyol is made using at least one propylene oxide based on at least one hydroperoxide.

35. The polyurethane product of claim 34, wherein the at least one autocatalytic polyol comprises at least one of primary and secondary amine end-capping groups.

36. The polyurethane product of claim 34, wherein the at least one HPPO polyether polyol is amine initiated.

37. The polyurethane product of claim 34, wherein the polyurethane product has a total VOC emission below 85 parts per million (ppm), as measured by the VDA 278 test method.

38. The polyurethane product of claim 34, wherein the polyurethane product has a total amine VOC emission below 10 parts ppm, as measured by the VDA 278 test method.
